(19) United States
(12) Patent Application Publication
(10) Pub. No.: US 2024/0313373 A1
(43) Pub. Date: Sep. 19, 2024

(54) SECONDARY BATTERY AND BATTERY MODULE INCLUDING THE SAME

(71) Applicant: LG ENERGY SOLUTION, LTD., Seoul (KR)

(72) Inventors: Han Saem PARK, Daejeon (KR); Jongseon KIM, Daejeon (KR); Ahae JO, Daejeon (KR); Hyeong Seop KANG, Daejeon (KR)

(73) Assignee: LG ENERGY SOLUTION, LTD., Seoul (KR)

(21) Appl. No.: 18/571,157

(22) PCT Filed: Sep. 14, 2022
(86) PCT No.: PCT/KR2022/013681

§ 371 Date: Dec. 15, 2023

(30) Foreign Application Priority Data
Sep. 14, 2021 (KR) 10-2021-0122354

(51) Int. Cl. H01M 50/583; H01M 10/04; H01M 50/107; H01M 50/152; H01M 50/474; H01M 50/477

(52) U.S. Cl. CPC H01M 50/583; H01M 10/0431; H01M 50/107; H01M 50/152; H01M 50/474; H01M 50/477; H01M 2200/103

(57) ABSTRACT

A secondary battery may include: an electrode assembly having first and second electrodes and a separator; a battery can having an open upper part; a cap assembly coupled to the opened upper part; a spacer between the electrode assembly and a bottom part of the battery can; and a spring part between the spacer and the bottom part. The first electrode may include a first electrode current collector and a first electrode extension part where the first electrode current collector is exposed in a lower direction. The second electrode may include a second electrode current collector and a second electrode extension part where the second electrode current collector is exposed in an upper direction. The first electrode extension part may contact the spacer. The second electrode extension part may contact the cap assembly. The spring part may include a protrusion part that protrudes toward the spacer and contacts the spacer.

### TECHNICAL FIELD

### CROSS-REFERENCE TO RELATED APPLICATION(S)

This application claims the benefit of Korean Patent Application No. 10-2021-0122354 filed on Sep. 14, 2021 with the Korean Intellectual Property Office, the entire contents of which are incorporated herein by reference.

The present disclosure relates to a secondary battery and a battery module including the same, and more particularly, to a secondary battery with improved safety and a battery module including the same.

### BACKGROUND

Recently, the demand for portable electronic products such as notebooks, video cameras, cellular phones or the like has rapidly increased, and electric vehicles, energy storage batteries, robots, satellites or the like have been actively developed. Thereby, many studies have been conducted on the secondary battery used as its driving power source.

The secondary battery includes, for example, a nickel cadmium battery, a nickel hydrogen battery, a nickel zinc battery, a lithium secondary battery, and the like. Among them, the lithium secondary batteries are widely used in the field of high-tech electronic devices because they have advantages, for example, hardly exhibiting memory effects in comparison with nickel-based secondary batteries and thus being freely charged and discharged, and having very low self-discharge rate, high operating voltage and high energy density per unit weight.

Depending on the shape of the battery case, a secondary battery is classified into a cylindrical battery where an electrode assembly is mounted in a cylindrical metal can, a prismatic battery where an electrode assembly is mounted in a prismatic metal can, and a pouch-type battery where an electrode assembly is mounted in a pouch type case formed of an aluminum laminate sheet. Among them, the cylindrical battery has an advantage that it has a relatively large capacity and is structurally stable.

The electrode assembly mounted in the battery case is an electricity-generating device enabling charge and discharge that has an anode/separator/cathode laminate structure, and is classified into a jelly-roll type, a stack type, and a stack/folding type. The jelly-roll type is a shape in which a separator interposed between an anode and a cathode, each made of an active material-coated long sheet, is rolled, the stack type is a shape in which a plurality of anodes and a plurality of cathodes each having a predetermined size are laminated in this order such that a separator is interposed therebetween, and a stack/folding type is a combination of a jelly-roll type and a stack type. Of these, the jelly-roll type electrode assembly has advantages that manufacture is easy and the energy density per weight is high.

Demand for cylindrical batteries capable of realizing high-capacity, low-resistance and fast-charge is increasing, but performance degradation and safety issues due to heat generated during fast-charging are emerging. Therefore, there is a need to develop a technology that can ensure the safety of secondary batteries against heat generation.

### DETAILED DESCRIPTION OF THE INVENTION

### Technical Problem

The present disclosure has been designed to solve the above-mentioned problems, and an object of the present disclosure is to provide a secondary battery that can ensure safety against overcurrent, and a battery module including the same.

However, the technical problem to be solved by embodiments of the present disclosure is not limited to the above-described problems, and can be variously expanded within the scope of the technical idea included in the present disclosure.

### Technical Solution

According to an embodiment of the present disclosure, there is provided a secondary battery comprising: a jelly-roll type electrode assembly in which a first electrode, a second electrode, and a separator are wound: a battery can that houses the electrode assembly and is opened in its upper part: a cap assembly coupled to the opened upper part of the battery can: a spacer positioned between the electrode assembly and the bottom part of the battery can: and a spring part positioned between the spacer and the bottom part of the battery can, wherein the first electrode includes a first electrode current collector and a first electrode extension part in which the first electrode current collector is extended and exposed in a lower direction of the electrode assembly, wherein the second electrode comprises a second electrode current collector and a second electrode extension part in which the second electrode current collector is extended and exposed in an upper direction of the electrode assembly, wherein the first electrode extension part contacts the spacer, and the second electrode extension part contacts the cap assembly, and wherein the spring part comprises a protrusion part that protrudes toward the spacer and contacts the spacer.

The protrusion part may comprise a metallic material that melts when an overcurrent flows.

When the overcurrent flows and the protrusion part melts, at least one of the contact between the first electrode extension part and the spacer or the contact between the second electrode extension part and the cap assembly may be released.

The spring part may be a wave spring.

The spring part may comprise upward bent parts and downward bent parts that are alternately positioned along a circumferential direction.

The protrusion part may be positioned on the upward bent part.

The first electrode may comprise a first electrode active material part formed by coating a first electrode active material onto the first electrode current collector, and the first electrode extension part may be extended in the lower direction than a region where the first electrode active material part is formed, and the second electrode may comprise a second electrode active material part formed by coating a second electrode active material onto the second electrode current collector, and the second electrode extension part may be extended in the upper direction than a region in which the second electrode active material part is formed.

An upper surface of the spacer facing the first electrode extension part may have a convexly protruded shape, and a lower surface of the spacer facing the spring part may have a flat shape.

The spacer may comprise a metallic material.

### Advantageous Effects

According to embodiments of the present disclosure, the spring part including the protrusion part can be disposed inside to thereby ensure structural stability and safety against overcurrent.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a perspective view showing a secondary battery according to one embodiment of the present disclosure:

FIG. 2 is an exploded perspective view of the secondary battery of FIG. 1:

FIG. 3 is a perspective view showing an electrode assembly according to one embodiment of the present disclosure;

FIG. 4 is a cross-sectional view showing a cross section cut along the cutting line C-C′ of FIG. 3:

FIG. 5 is a perspective view showing a spring part according to one embodiment of the present disclosure;

FIG. 6 is a partial cross-sectional view showing a cross section taken along the cutting line A-A′ of FIG. 1;

FIG. 7 is a partial cross-sectional view showing a cross section cut along the cutting line B-B′ of FIG. 1;

FIG. 8 is a partial cross-sectional view showing a state in an overcurrent situation with respect to a cross section taken along the cutting line A-A′ of FIG. 1; and

FIG. 9 is a partial cross-sectional view showing a state in an overcurrent situation with respect to a cross section cut along the cutting line B-B′ of FIG. 1.

### DETAILED DESCRIPTION OF THE EMBODIMENTS

Hereinafter, various embodiments of the present disclosure will be described in detail with reference to the accompanying drawings so that those skilled in the art can easily implement them. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of some layers and regions are exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means disposed on or below a reference portion, and does not necessarily mean being disposed on the upper end of the reference portion toward the opposite direction of gravity.

Further, throughout the description, when a portion is referred to as “including” a certain component, it means that the portion can further include other components, without excluding the other components, unless otherwise stated.

Further, throughout the description, when referred to as “planar”, it means when a target portion is viewed from the upper side, and when referred to as “cross-sectional”, it means when a target portion is viewed from the side of a cross section cut vertically.

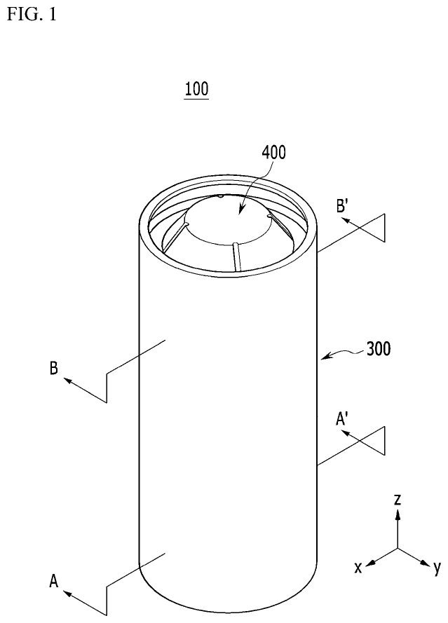

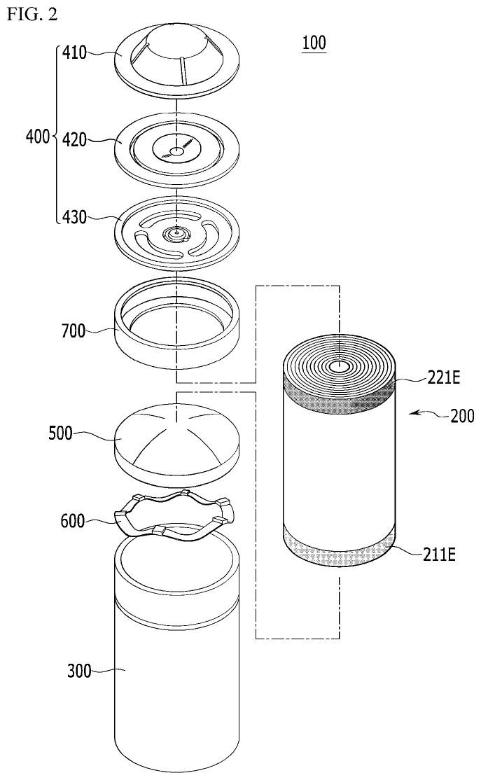

FIG. 1 is a perspective view showing a secondary battery according to one embodiment of the present disclosure. FIG. 2 is an exploded perspective view of the secondary battery of FIG. 1.

Referring to FIGS. 1 and 2 together, a secondary battery 100 according to one embodiment of the present disclosure includes a jelly-roll type electrode assembly 200: a battery can 300 that houses the electrode assembly 200 and is opened in its upper part: a cap assembly 400 coupled to the opened upper part of the battery can 300; a spacer 500 positioned between the electrode assembly 200 and the bottom part of the battery can 300: and a spring part 600 positioned between the spacer 500 and the bottom part of the battery can 300.

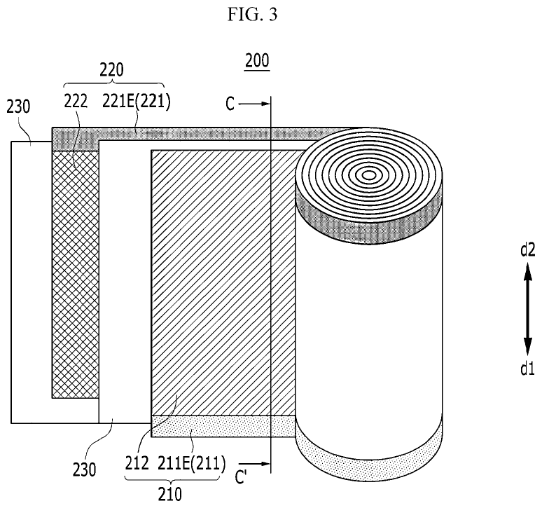

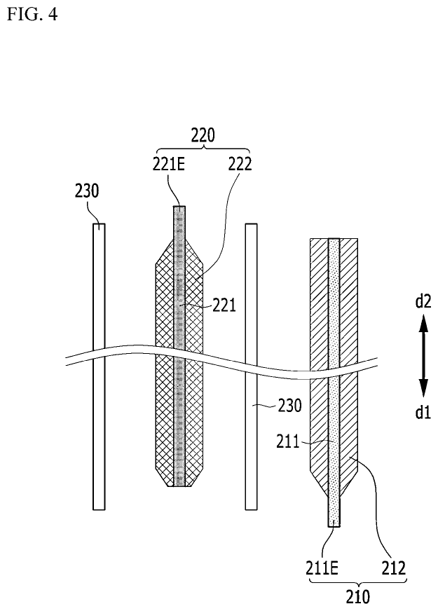

First, the electrode assembly 200 according to the present embodiment will be described in detail with reference to FIGS. 3 and 4. FIG. 3 is a perspective view showing an electrode assembly according to one embodiment of the present disclosure. FIG. 4 is a cross-sectional view showing a cross section cut along the cutting line C-C′ of FIG. 3.

Referring to FIGS. 3 and 4, the electrode assembly 200 according to the present embodiment includes a first electrode 210, a second electrode 220 and a separator 230. The first electrode 210, the second electrode 220, and the separator 230 are wound together to form a jelly-roll type electrode assembly 200. The separator 230 is positioned between the first electrode 210 and the second electrode 220. In addition, it is preferable to further dispose a separator 230 on the outer side in order to prevent the first electrode 210 and the second electrode 220 from coming into contact with each other when rolled up in a jelly roll form.

The first electrode 210 includes a first electrode current collector 211 and a first electrode extension part 211E in which the first electrode current collector 211 is extended and exposed in the lower direction d1 of the electrode assembly 200. Specifically, the first electrode 210 further includes a first electrode active material part 212 formed by coating the first electrode active material onto the first electrode current collector 211. As shown in the figure, the first electrode active material can be coated on both surfaces of the first electrode current collector 211 to form the first electrode active material part 212. The first electrode active material cannot be coated onto the surface of the portion of the first electrode current collector 211 extending in the lower direction d1 of the electrode assembly 200 to form a first electrode extension part 211E. The first electrode extension part 211E may be extended in a lower direction d1 than a region where the first electrode active material part 212 is formed, and may extend along one end of the first electrode 210 to be wound. Further, the first electrode extension part 211E may extend more than the separator 230 in the lower direction d1. Accordingly, the first electrode extension part 211E may be exposed at one end of the jelly-roll type electrode assembly 200 in the lower direction d1.

The second electrode 220 includes a second electrode current collector 221 and a second electrode extension part 221E in which the second electrode current collector 221 is extended and exposed in the upper direction d2 of the electrode assembly 200. Specifically, the second electrode 220 further includes a second electrode active material part 222 formed by coating the second electrode active material onto the second electrode current collector 221. As shown in the figure, the second electrode active material may be coated onto both surfaces of the second electrode current collector 221 to form the second electrode active material part 222. The second electrode active material cannot be coated onto the surface of the portion of the second electrode current collector 221 extending in the upper direction d2 of the electrode assembly 200 to form a second electrode extension part 221E. The second electrode extension part 221E may be extended in an upper direction d2 than a region where the second electrode active material part 222 is formed, and may extend along one end of the second electrode 220 to be wound. In addition, the second electrode extension part 221E extends more than the separator 230 in the upper direction d2. Accordingly, the second electrode extension part 221E may be exposed at one end of the jelly-roll type electrode assembly 200 in the upper direction d2.

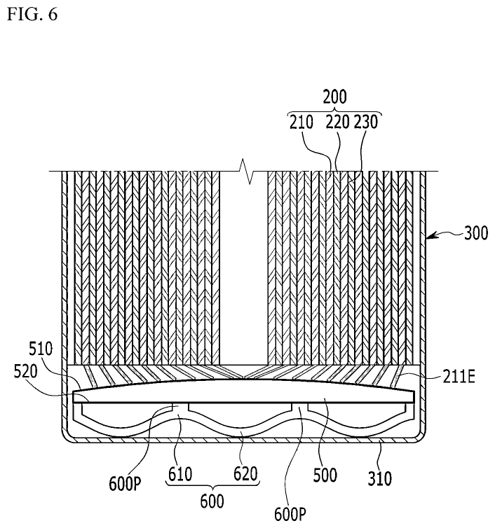

At this time, the lower direction d1 may be a direction in which the bottom part 310 (see FIG. 6) of the battery can 300 is positioned on the basis of the electrode assembly 200, and the upper direction d2 may be a direction in which the cap assembly 400 is positioned on the basis of the electrode assembly 200. Further, the first electrode 210 may be an anode, and the second electrode 220 may be a cathode.

The electrode assembly 200 according to the present embodiment does not have a form of attaching a separate electrode tab, but has a form in which a first electrode extension part 211E formed by extending the first electrode current collector 211 and a second electrode extension part 221E formed by extending the second electrode current collector 221 are used as a current path instead of the electrode tab in order to reduce the resistance. That is, the electrode assembly 200 according to the present embodiment may be a tab-less electrode assembly.

Referring to FIGS. 1 and 2 again, the battery can 300 has a structure that houses the electrolyte and the electrode assembly 200, and may include a metallic material and may be a cylindrical case.

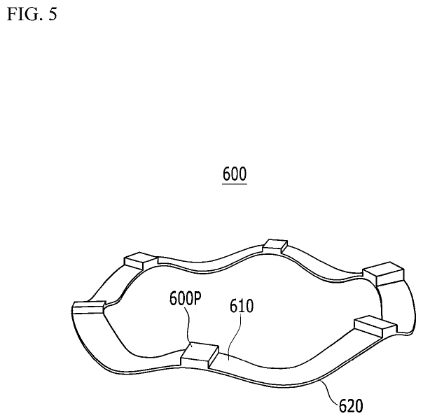

Next, the spacer and the spring part according to the present embodiment will be described in detail with reference to FIGS. 5 and 6.

FIG. 5 is a perspective view showing a spring part according to one embodiment of the present disclosure. FIG. 6 is a partial cross-sectional view showing a cross section taken along the cutting line A-A′ of FIG. 1.

Referring to FIGS. 2, 5 and 6 together, the spacer 500 is positioned between the electrode assembly 200 and the bottom part 310 of the battery can 300, and the spring part 600 is positioned between the spacer 500 and the bottom part 310 of the battery can 300, as described above. That is, the spacer 500, the spring part 600, and the bottom part 310 of the battery can 300 may be sequentially positioned under the electrode assembly 200.

The first electrode extension part 211E according to the present embodiment contacts the spacer 500. Specifically, the first electrode extension part 211E may contact the upper surface 510 of the spacer 500, and the spring part 600 may contact the lower surface 520 of the spacer 500. In addition, the spring part 600 may contact the bottom part 310 of the battery can 300.

The first electrode extension part 211E may guide the electrical connection of the electrode assembly 200 instead of the electrode tab. Specifically, the electrode assembly 200 may be electrically connected with the bottom part 310 of the battery can 300 through the first electrode extension part 211E, the spacer 500, and the spring part 600, and the bottom partn 310 may function as an electrode terminal of the secondary battery 100. When the first electrode 210 is an anode, the bottom part 310 may function as an anode terminal. For this operating principle, both the spacer 500 and the spring part 600 may include a metallic material having excellent electrical conductivity.

At this time, the spring part 600 is a member having elasticity in the upward and downward directions, and may be a wave spring as shown in FIG. 5. That is, the spring part 600 according to the present embodiment may include upward bent parts 610 and downward bent parts 620 that are alternately positioned along the circumferential direction. The upward bent part 610 is a portion bent toward the spacer 500, and the downward bent part 620 is a portion bent toward the bottom part 310 of the battery can 300. As will be described later, the protrusion part 600P formed on the upward bent part 610 can contact the lower surface 520 of the spacer 500, and the downward bent parts 620 may contact the bottom part 310 of the battery can 300.

Due to the elastic force of the spring part 600, the electrode assembly 200 is strongly fixed between the spacer 500 and the cap assembly 400, which will be described later, so that they can maintain mutual contact therebetween. Accordingly, it is possible to prevent the electrode assembly 200 from flowing inside the secondary battery 100 to increase structural stability, and at the same time, stably ensure electrical connection.

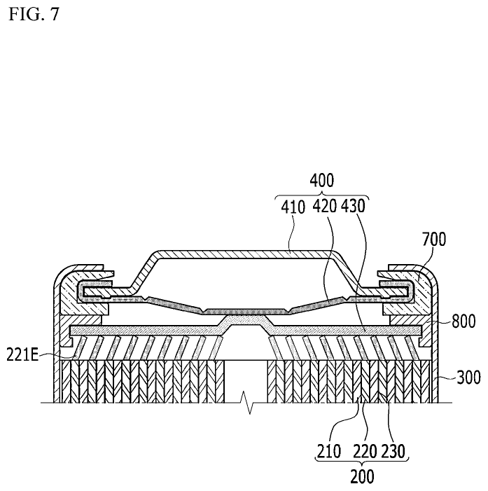

Next, the cap assembly and the second electrode extension part 221E according to the present embodiment will be described in detail with reference to FIGS. 2 and 7.

FIG. 7 is a partial cross-sectional view showing a cross section cut along the cutting line B-B′ of FIG. 1.

Referring to FIGS. 2 and 7 together, the second electrode extension part 221E according to the present embodiment contacts the cap assembly 400. Specifically, the cap assembly 400 according to the present embodiment may include a top cap 410, a safety vent 420, and a CID (current interrupt device) filter 430. The top cap 410 and the safety vent 420 may form a structure in close contact with each other. The safety vent 420 is positioned on the CID filter 430 and may be electrically connected to the CID filter 430. Specifically, the center of the safety vent 420 and the center of the CID filter 430 may be physically and electrically connected. The second electrode extension part 221E may contact the lower surface of the CID filter 430.

The safety vent 420 is a thin film structure through which current passes, and may be formed so that its center protrudes in a lower direction, that is, in a direction where the CID filter 430 is positioned. The CID filter 430 is a plate member through which current passes, and may have a plurality of through-holes for discharging gas.

The top cap 410, the safety vent 420, the CID filter 430, and the second electrode extension part 221E may be sequentially connected. The second electrode extension 221E may guide the electrical connection of the electrode assembly 200 instead of the electrode tab. The top cap 410, the safety vent 420, the CID filter 430, and the second electrode extension part 221E are electrically connected with each other, and the top cap 410 may function as an electrode terminal that guides electrical connection of the electrode assembly 200. When the second electrode 220 is a cathode, the top cap 410 of the cap assembly 400 may function as a cathode terminal.

Meanwhile, when the internal pressure of the secondary battery 100 increases, the shape of the safety vent 420 is reversed, and a portion of the CID filter 430 connected to the safety vent 420 and a portion not connected to the safety vent 420 are separated from each other to interrupt current.

Meanwhile, a gasket 700 may be positioned between the battery can 300 and the cap assembly 400. Specifically, crimping coupling may be performed by placing a gasket 700 between the upper end of the battery can 300 and the cap assembly 400 and bending the upper end of the battery can 300. Such a crimping coupling method allows the cap assembly 400 to be coupled to the opened top of the battery can 300. The gasket 700 may enhance sealing performance between the battery can 300 and the cap assembly 400 and at the same time, interrupt electrical connection between the battery can 300 and the cap assembly 400.

In addition, a CID gasket 800 is disposed on the outer circumference of the CID filter 430 to fix the CID filter 430 and, at the same time, interrupt the contact between the outer circumferential part of the CID gasket 800 and the outer circumferential part of the safety vent 420.

Next, the current interrupt function of the spring part 600 according to the present embodiment will be described in detail.

First, referring to FIGS. 2 and 5 again, the spring part 600 according to one embodiment of the present disclosure includes a protrusion part 600P that protrudes toward the spacer 500 and contacts the spacer 500. More specifically, the spring part 600 may be a wave spring including upward bent parts 610 and downward bent parts 620, the protrusion part 600P is formed by a plurality of numbers, and each of the protrusion parts 600P may be positioned on the upward bent part 610. The spring part 600 may contact the spacer 500 through the protrusion part 600P to form a current path.

At this time, the protrusion part 600P according to the present embodiment may include a metallic material that melts when an overcurrent flows. That is, the protrusion part 600P may function as a kind of fuse. Specifically, the protrusion part 600P may be made of a material that melts when a first current or more flows or when heat of a first temperature or more is applied. Here, the first temperature may be a temperature at which an abnormal phenomenon occurs in the secondary battery 100, for example, a short circuit occurs and an overcurrent flows. More specifically, it may be the temperature of resistance heat generated when a current greater than or equal to the first current flows through the electrode assembly 200. The first current may be 10C (C-rate). That is, the protrusion part 600P may be designed to be melted as a current of 10C or more flows. In the present invention, overcurrent may mean a current greater than or equal to the first current. Further, the first temperature may be a temperature of 100 degrees Celsius or more. That is, the protrusion part 600P may be melted as heat having a temperature of 100 degrees Celsius or higher is transferred.

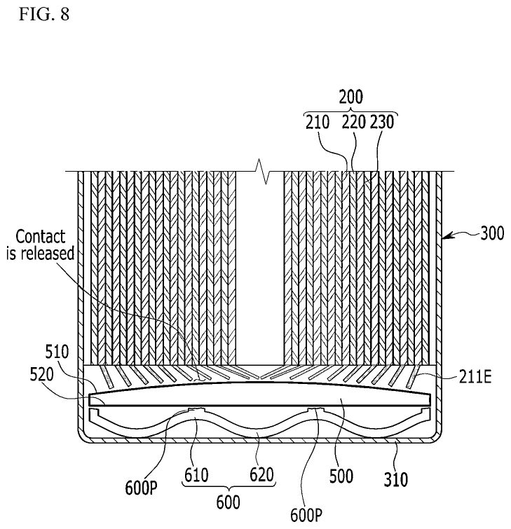

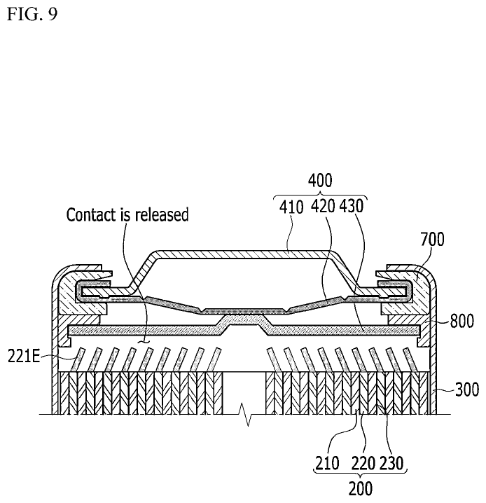

Accordingly, when a current of 10C (C-rate) or more flows through the protrusion part 600P and/or when heat having a temperature of 100 degrees Celsius or more is transferred, the protrusion part 600P may be melted. FIGS. 8 and 9 show the state of the secondary battery when the overcurrent flows and the protrusion part 600P melts. FIG. 8 is a partial cross-sectional view showing a state in an overcurrent situation with respect to a cross section taken along the cutting line A-A′ of FIG. 1. FIG. 9 is a partial cross-sectional view showing a state in an overcurrent situation with respect to a cross section cut along the cutting line B-B′ of FIG. 1.

When an overcurrent flows and the protrusion part 600P melts, at least one of the contact between the first electrode extension part 211E and the spacer 500 or the contact between the second electrode extension 221E and the cap assembly 400 may be released. That is, either the contact between the first electrode extension part 211E and the spacer 500 or the contact between the second electrode extension 221E and the cap assembly 400 may be released, or both the contact between the first electrode extension part 211E and the spacer 500 and the contact between the second electrode extension part 221E and the cap assembly 400 may be released.

FIG. 8 shows a state in which the contact between the first electrode extension part 211E and the spacer 500 is released, and FIG. 9 shows a state in which the contact between the second electrode extension part 221E and the cap assembly 400 is released.

As described above, even if an abnormal operating state in which overcurrent flows occurs, the protrusion part 600P functioning as a fuse can interrupt the flow of current inside the secondary battery, thereby ensuring safety against heat generation and preventing explosion or ignition.

The protrusion part 600P may contain mainly zinc (Zn), tin (Sn), lead (Pb), or may be formed of an alloy containing mainly these. The protrusion part 600P may include one or more metallic materials selected from the group consisting of zinc, tin, and lead. As an example, the protrusion part 600P may include a Pb-Sn (lead-tin) alloy. Alternatively, the protrusion part 600P may include a copper (Cu) or silver (Ag) based material. However, the protrusion part 600P is not limited to the materials described above, and may also include a material included in a conventional fuse.

When the protrusion part 600P includes a Pb-Sn (lead-tin) alloy, the protrusion part 600P may be made of an alloy containing 30 wt. % to 45 wt. % of lead (Pb) and 55 wt. % to 70 wt. % of tin (Sn). More specifically, the protrusion part 600P may be made of an alloy containing 33 wt. % to 43 wt. % of lead (Pb) and 57 wt. % to 67 wt. % of tin (Sn). As an example, the protrusion part 600P may be made of an alloy containing 35 wt. % to 40 wt. % of lead (Pb) and 60 wt. % to 65 wt. % of tin (Sn).

Accordingly, the protrusion part 600P may include a Pb—Sn (lead-tin) alloy at a ratio within the above-described range, and the phase change from solid to liquid can proceed according to the heat generation temperature due to the occurrence of a short circuit. Current flow can be interrupted as described above in response to the phase change of the protrusion part 600P.

Meanwhile, if the protrusion part 600P according to the present embodiment protrudes toward the spacer 500, the form thereof is not particularly limited. However, for stable contact with the spacer 500, it may be a rectangular parallelepiped protrusion part 600P as shown in FIG. 5.

Moreover, the method of forming the protrusion part 600P is not particularly limited. As an example, the protrusion part 600P may be integrally formed with other parts of the spring part 600. That is, the entire spring part 600 including the protrusion part 600P may be made of a metallic material that melts in an overcurrent, such as a Pb—Sn (lead-tin) alloy, and the protrusion part 600P may be integrally molded with the other spring part 600. As another example, the protrusion part 600P including a metallic material that melts in overcurrent, such as a Pb—Sn (lead-tin) alloy, may be joined to a spring part 600 including another metallic material by welding or the like.

Meanwhile, referring to FIG. 6 again, the upper surface 510 facing the first electrode extension part 211E of the spacer 500 according to the present embodiment may have a convexly protruded shape, and a lower surface 520 of spacer 500 facing spring part 600 may have a flat shape. The first electrode extension part 211E may be configured to have a shape in which the protrusion part decreases from the outer portion of the electrode assembly 200 toward the central part, that is, a concave shape. That is, the lower surface of the jelly-roll type electrode assembly 200 formed by the wound first electrode extension part 211E may have a concave shape in which the central part is more inward than the outer portion. The spacer 500 may have an upper surface protruding convexly in order to increase contact with the first electrode extension part 211E. That is, the contact between the spacer 500 and the first electrode extension part 211E may be stably maintained through the concave first electrode extension part 211E and the spacer 500 protruded so as to correspond thereto. Meanwhile, the lower surface 520 of the spacer 500 may have a flat shape so as to contact the protrusion part 600P of the spring part 600.

The terms representing directions such as the front side, the rear side, the left side, the right side, the upper side, and the lower side have been used in the present embodiment, but the terms used are provided simply for convenience of description and may become different according to the position of an object, the position of an observer, or the like.

The secondary batteries according to the present embodiment described above can be gathered by a plurality of numbers to form a battery module. The battery modules can be mounted together with various control and protection systems such as a BMS(battery management system), a BDU(battery disconnect unit), and a cooling system to form a battery pack.

The secondary battery, the battery module or the battery pack can be applied to various devices. For example, they can be applied to vehicle means such as an electric bike, an electric vehicle, and a hybrid electric vehicle, or ESS (Energy Storage System), but is not limited thereto and can be applied to various devices that can use secondary batteries.

Although preferred embodiments of the present disclosure have been described in detail above, the scope of the present disclosure is not limited thereto, and various modifications and improvements can be made by those skilled in the art using the basic concepts of the present disclosure as defined in the appended claims, which also falls within the scope of the present disclosure.

### DESCRIPTION OF REFERENCE NUMERALS

100: secondary battery
200: electrode assembly
300: battery can
400: cap assembly
500: spacer
600: spring part
600P: protrusion part

1. A secondary battery, comprising:
an electrode assembly in which a first electrode, a second electrode, and a separator are wound, wherein the electrode assembly is a jelly-roll type;
a battery can that houses the electrode assembly and is opened at an upper part of the battery can;
a cap assembly coupled to the opened upper part of the battery can;
a spacer positioned between the electrode assembly and the a bottom part of the battery can; and
a spring part positioned between the spacer and the bottom part of the battery can,
wherein the first electrode includes a first electrode current collector and a first electrode extension part in which the first electrode current collector is extended and exposed in a lower direction of the electrode assembly,
wherein the second electrode comprises a second electrode current collector and a second electrode extension part in which the second electrode current collector is extended and exposed in an upper direction of the electrode assembly,
wherein the first electrode extension part contacts the spacer, and the second electrode extension part contacts the cap assembly, and
wherein the spring part comprises a protrusion part that protrudes toward the spacer and contacts the spacer.

2. The secondary battery of claim 1, wherein:
the protrusion part comprises a metallic material that melts when an overcurrent flows.

3. The secondary battery of claim 2, wherein:
when the overcurrent flows and the metallic material melts, at least one of a contact between the first electrode extension part and the spacer or a contact between the second electrode extension part and the cap assembly is released.

4. The secondary battery of claim 1, wherein:
the spring part is a wave spring.

5. The secondary battery of claim 4, wherein:
the spring part comprises upward bent parts and downward bent parts that are alternately positioned along a circumferential direction.

6. The secondary battery of claim 5, wherein:
the protrusion part is positioned on at least one of the upward bent parts.

7. The secondary battery of claim 1, wherein:
the first electrode comprises a first electrode active material part formed by coating a first electrode active material onto the first electrode current collector, and the first electrode extension part is extended in the lower direction and disposed in an area that is lower than a region where the first electrode active material part is formed, and
the second electrode comprises a second electrode active material part formed by coating a second electrode active material onto the second electrode current collector, and the second electrode extension part is extended in the upper direction and disposed in an area that is above a region in which the second electrode active material part is formed.

8. The secondary battery of claim 1, wherein:
an upper surface of the spacer facing the first electrode extension part has a convexly protruded shape, and
a lower surface of the spacer facing the spring part has a flat shape.

9. The secondary battery of claim 1, wherein:
the spacer comprises a metallic material.

10. A battery module comprising the secondary battery of claim 1.
